(19) United States
(12) Patent Application Publication
(10) Pub. No.: US 2002/0112233 A1
(43) Pub. Date: Aug. 15, 2002

(54) Method and system for providing network based advertising services

(75) Inventors: Jorge Cantu Bonilla, Guadelupe (MX); Mabel Morales Trevino, San Pedro Garza Garcia (MX)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EuphoriaNET, Inc., Wilmington New Castle, DE (US)

(21) Appl. No.: 10/074,378

(22) Filed: Feb. 11, 2002

Related U.S. Application Data
(60) Provisional application No. 60/269,650, filed on Feb. 14, 2001.

(51) Int. Cl. H04N 7/16; H04H 9/00; H04N 7/173; H04N 7/025; H04N 7/10

(52) U.S. Cl. 725/23; 725/24; 725/13; 725/9; 725/32

(57) ABSTRACT

A method and system for providing advertising services to an entity is provided. The method comprises the steps of presenting a question to a user to which advertisements are directed, the question being about a product or service being advertised by the entity; soliciting an answer to the question from the user; and providing an incentive to the user if the user answers the question correctly. The step of presenting a question may further comprise presenting a question about a feature of the product or service being advertised. The step of soliciting an answer may further comprise directing the user to the entity's web page to find the answer to the question. And the step of providing an incentive may further comprise providing gaming credits to the user, and the user can use the game credits to play games online.

### BACKGROUND OF THE INVENTION

The present invention relates generally to methods and systems for providing online advertising services to entities, and more particularly, to methods and systems for providing online advertising services to an entity by enticing a network user to learn about the entity's product or service.

Advertising on the Internet typically has been provided by presenting banner advertisements to Internet users. When banner ads first were presented on web pages, about 1 out of every 10 users selected the banner ad to learn more about the product or service. However, as the frequency of banner ads has increased, users have stopped paying attention to those ads. Specifically, instead of 1 out of every 10 users selecting a banner ad, now, only about 1 out of every 200 users select banner ads. Clearly, the effectiveness of banner advertisements on the Internet has decreased significantly.

Thus, what is needed are systems and methods for more effectively presenting online advertisements to Internet users.

### SUMMARY OF THE INVENTION

In accordance with one embodiment of the present invention, a method of providing advertising services to an entity is provided. The method comprises the steps of presenting a question to a user to which advertisements are directed, the question being about a product or service being advertised by the entity; soliciting an answer to the question from the user; and providing an incentive to the user if the user answers the question correctly. In accordance with one embodiment of the present invention, the step of presenting a question further comprises presenting a question about a feature of the product or service being advertised.

In accordance with yet another embodiment of the present invention, the step of soliciting an answer further comprises directing the user to the entity's web page to find the answer to the question.

In accordance with yet another embodiment of the present invention, the step of providing an incentive further comprises providing gaming credits to the user, and wherein the user is allowed to play games online using the gaming credits.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram showing a method of providing advertising services to an entity by enticing a network user to learn about the entity's product or service;

FIG. 2 is a screen shot of a page for providing advertising services to entities;

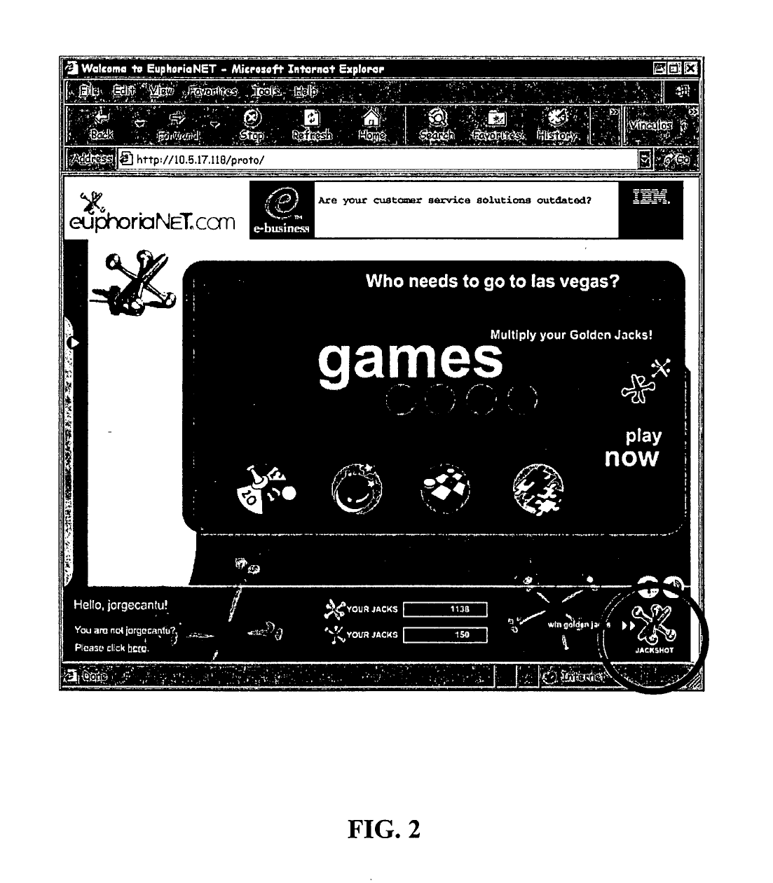

FIG. 3 is a screen shot of a page showing an advertising entity's page along with a question about a product being advertised by the advertising entity; and

FIG. 4 is a screen shot of a page showing the advertising entity's page along with a result provided after the question is answered.

### DESCRIPTION OF THE SPECIFIC EMBODIMENTS

The present invention relates generally to methods and systems for providing online advertising services to entities, and more particularly, to methods and systems for providing online advertising services to an entity by enticing a network user to learn about the entity's product or service.

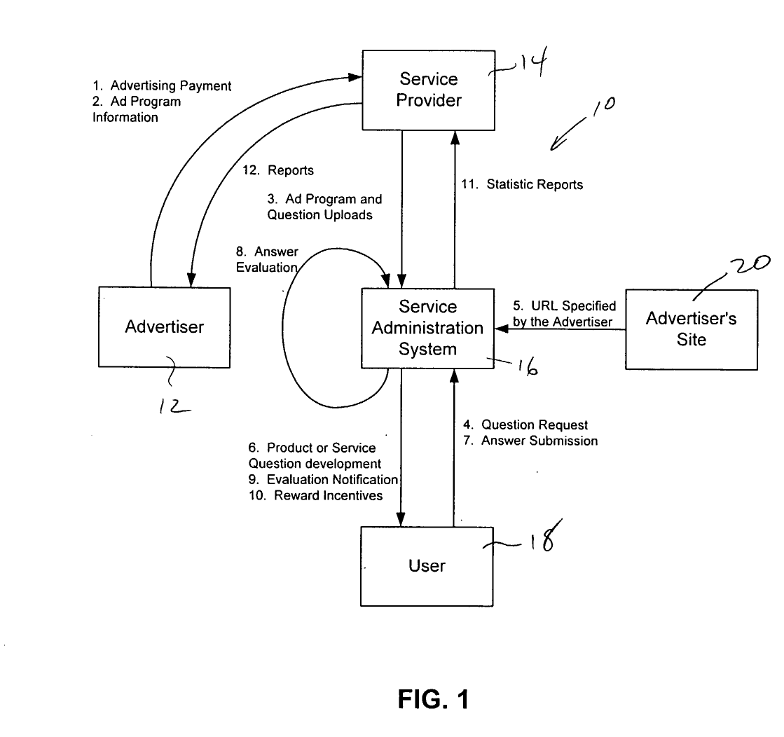

Referring now to FIG. 1, one embodiment of a system and method 10 for providing advertising services will be described. In accordance with the present embodiment, an advertiser 12 requests an advertising service provider 14 to provide online advertising services to users 18 for it. Service provider 14 can be an online service provider, a web portal or hosting company providing advertising services to customers, a marketing division within a company providing advertising services to its company, or any other suitable service provider.

A request for advertising services by advertiser 12 may include any information need by service provider 14. For example, in accordance with one embodiment of the present invention, advertiser 12 provides service provider 14 with the following information (step 2):

A. The product or service that is to be advertised or promoted;

B. One or more characteristics of the product or service being advertised to which advertiser 12 would like a web user to pay particular attention;

C. A URL for a web page describing or advertising the product or service (the web page may contain visual, written, or audio information needed for the user to understand the one or more characteristics that advertiser 12 would like to be noted);

D. An advertising campaign end date;

E. The number of questions to be presented to a user regarding the product or service being advertised;

F. The type and quantity of incentive to be awarded to the user in the case he/she answers the trivia question(s) correctly; and

G. Any other information necessary to correctly elaborate a question. After service provider 14 receives this information from advertiser 12, it stores the information on a service provider server or other suitable storage location 16 (step 3). In addition, service provider 14 may obtain and store additional information about product or service related questions, such as, one or more particular questions about the product or service being advertised, the question format and answer options, the correct answer, if there is one (some questions may be to evaluate the users preferences towards a characteristic of the product, and therefore all answers will be correct), and any other data that may be needed to personalize an advertising campaign. Moreover, advertiser 12 may pay service provider 14 a fee for providing the advertising services (step 1).

When a user 18 sees information about product question, or if user 18 would like to obtain incentive credits, for example, gaming credits for playing online games, the user can request a question about a product or service at the click of a button (step 4). The product or service questions can be provided to user 18 in banner ads, emails, or from any suitable web page. Once user 18 sees a question, user 18 can select the question by any suitable online selection process, for example, double clicking, dragging-and-dropping, etc.

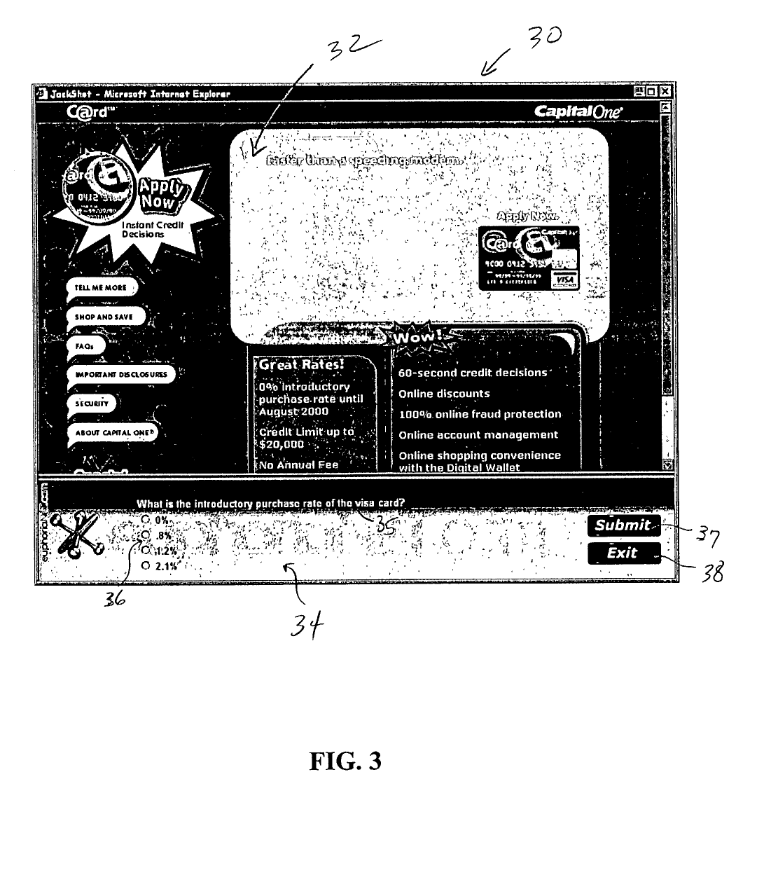

After user 18 selects a particular question, system 16 associated with service provider 14 integrates a product web page from an advertiser's web site or server 20 with the question into a single window or web page (step 5). As one skilled in the art will appreciate, web page framing may be used to integrate the two separate pages. FIG. 3 illustrates a page having a advertised product page 32 integrated with an advertising question 34.

The question then is delivered to the user in a new Internet or web page window (step 6). As illustrated in FIG. 3, a section 34 of the new window 30 will contain the trivia question 35, the answer options 36, a button 37 to submit the answer, and another button 38 to exit the page with the question and advertising window 32. If exit button 38 is selected, user 18 will not get incentive credits for answering the question. The upper portion 32 of page 30 may contain a link to the advertiser's product page, or the actual product page itself (as illustrated in FIG. 3). The advertiser's product page preferably includes the information user 18 needs to correctly answer the question, or a link or references for the user to easily find the correct answer to the question.

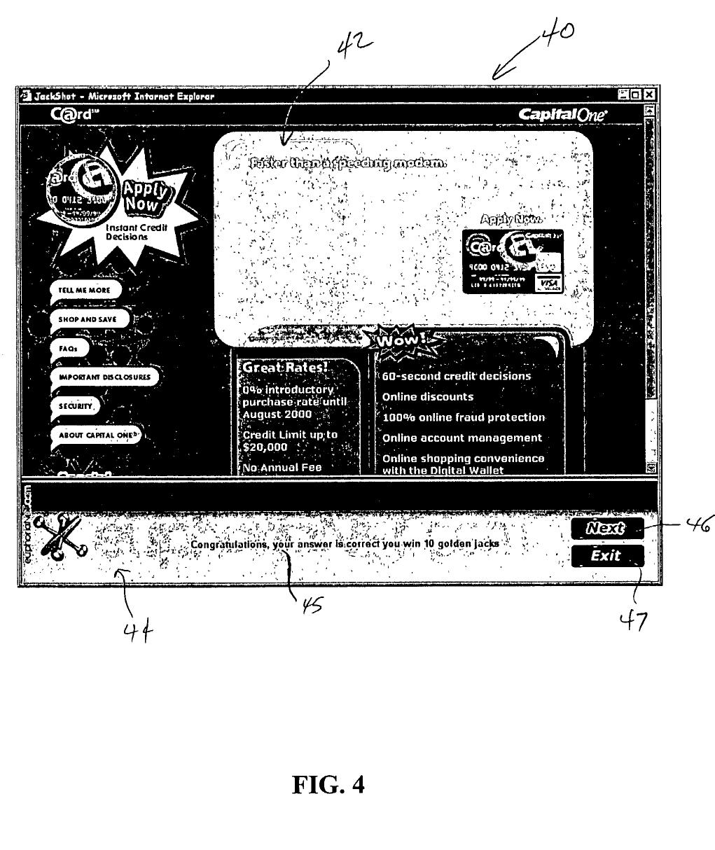

Once user 18 determines the correct answer (for example, by reviewing the product page), the user selects the answer from the list of answers 36 and selects the submit button 37 (step 7). System 16 then will evaluate the submitted answer in order to determine if it is in accordance with that which was assigned as the right answer or answers (step 8). System 16 then will notify user 18 whether the submitted answer was correct (step 9). In accordance with one embodiment of the present invention, user 18 will receive a notification in a window similar to the window in which the question was placed. For example, as illustrated in FIG. 4, a window or page 40 may include the advertiser's product page 42 and a result window 44. Result window 44 includes a message 45 telling user 18 whether the question was answered correctly or not. Result window 44 also may include a “Next” button 46 for advancing to a next question, if one exists, and an “Exit” button 47.

When user 18 submits a correct answer to a question, system 16 then will credit user 18 with the appropriate incentive credits specified at the time the question was displayed (step 10). User 18 then will be given the option to ask for a new question, in case there is availability of such in the database.

The incentive credits may be any form of credit, such as product Coupons, actual money, free products or prizes, gaming credits of the like. In accordance with one embodiment of the present invention, the incentive credits are gaming credits that can be used to play online games, such as poker, black jack, craps, let-it-ride, roulette, or any other suitable online game. In accordance with this aspect of the present invention, the credits can function like gambling dollars. The user will not win actual cash by playing with the gaming credits, but may be able to win coupons, products, services or discounts on the same. For example, part of the advertising campaign may be to give away certain products or services or give discounts if a certain number of gaming credits are collected. As one skilled in the art will appreciate, any number of incentive programs may be used or developed in accordance with the present invention.

As users answer questions and visit advertiser's web pages, system 16 will track this activity and generate a statistical report with information relative to the profiles of the users that answered questions and the ratio of correct/incorrect answers given by users (step 11). Service provider 14 then will send the reports to the advertisers for each of the advertising campaigns. These reports can be used to determine the amount paid to service provider 14. The reports can be used to illustrate the effectiveness of the advertising campaign and the number and types of people the campaign reached. As one skilled in the art will appreciate, the reports can illustrate any demographic information wanted or needed.

The advertising systems and methods of the present invention are beneficial because they ensure advertisements and product or service web pages will attract the user's attention. As such the advertising systems and methods of the present invention will better develop brand recognition, collect statistic information on the users interest in the advertised products, services and/or websites, develop real Internet awareness, and increase sales.

In conclusion, the present invention provides novel methods and novel systems for implementing the methods of providing advertising services to entities. While a detailed description of presently preferred embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method of providing advertising services to an entity, comprising the steps of:
presenting a question to a user to which advertisements are directed, the question being about a product or service being advertised by the entity;
soliciting an answer to the question from the user; and
providing an incentive to the user if the user answers the question correctly.

2. The method as recited in claim 1, wherein the step of presenting a question further comprises presenting a question about a feature of the product or service being advertised.

3. The method as recited in claim 1, wherein the step of soliciting an answer further comprises directing the user to the entity's web page to find the answer to the question.

4. The method as recited in claim 1, wherein the step of providing an incentive further comprises providing gaming credits to the user.

5. The method as recited in claim 4, further comprising the step of allowing the user to play games online with the gaming credits.
